(19) United States
(12) Patent Application Publication
(10) Pub. No.: US 2021/0283823 A1
(43) Pub. Date: Sep. 16, 2021

(54) APPARATUS FOR SORTING PIECE GOODS WITH DISPENSING DEVICE

(71) Applicant: KRONES AG, Neutraubling (DE)

(72) Inventor: JÜRGEN BEUTL, SINZING (DE)

(21) Appl. No.: 16/338,889

(22) PCT Filed: Sep. 21, 2017
(86) PCT No.: PCT/EP2017/073902

§ 371 Date: Apr. 2, 2019

(30) Foreign Application Priority Data
Oct. 7, 2016 (DE) 20 2016 105 590.3

(51) Int. Cl. B29C 49/42; B65G 47/84; B65G 47/14

(52) U.S. Cl. CPC B29C 49/4205; B29C 2049/4231; B65G 47/1492; B65G 47/846

(57) ABSTRACT

Provided is an apparatus for sorting piece goods and in particular plastic parisons with a delivery device which delivers the piece goods and with a sorting device which is arranged in a transport direction of the piece goods after the delivery device and is suitable for aligning the piece goods at least partially, and with a dispensing device which is arranged in the transport direction of the piece goods between the delivery device and the sorting device and which conveys the piece goods from the delivery device to the sorting device and is suitable and intended for dispensing the piece goods reaching the sorting device from the delivery device, wherein the dispensing device includes a body which is rotatable about a predetermined axis of rotation and on this body a receiver is arranged for receiving a predetermined number of piece goods.

### CROSS-REFERENCE TO RELATED APPLICATIONS

This application claims priority to PCT Application No. PCT/EP2017/073902, having a filing date of Sep. 21, 2017, based on German Application No. 20 2016 105 590.3, having a filing date of Oct. 7, 2016, the entire contents both of which are hereby incorporated by reference.

### FIELD OF TECHNOLOGY

The following relates to an apparatus for sorting piece goods and in particular so-called plastic parisons. In the beverage production industry, it is known that plastic parisons are heated and then in this heated state are blow moulded to form plastic containers, in particular plastic bottles. Usually for this purpose the plastic parisons must be supplied already in an ordered manner to an oven.

### BACKGROUND

Therefore, sorting devices, the object of which is to bring disordered plastic parisons into line and finally to enable these plastic parisons to be transported individually, are known from the art. In this case for example so-called roller sorters are known from the prior art. These roller sorters have two rotating rollers parallel to one another, between which the plastic parisons are guided. In this case the plastic parisons remain caught by their carrying ring between the two rollers, but the rest of the body of the plastic parisons passes through the gap between the rollers. In this way an alignment of the plastic parisons is achieved.

From the art it is known that these roller sorters are supplied by means of a feeder belt, giving rise to the problem that uniform filling is not possible. The fed quantity of plastic parisons fluctuates significantly, so that this also has a negative effect on the sorting operation.

### SUMMARY

An apparatus according to embodiments of the invention for sorting piece goods (objects in general) and in particular plastic parisons has a delivery device which delivers the piece goods (objects) as well as a sorting device which is arranged downstream of the delivery device in a transport direction of the piece goods and is suitable and intended for at least partial alignment of the piece goods.

According to embodiments of the invention the apparatus has an (object) dispensing device which is arranged in the transport direction of the piece goods between the delivery device and the sorting device, and which conveys the piece goods from the delivery device to the sorting device and which is suitable and intended to dispense the piece goods arriving at the sorting device from the delivery device.

It is therefore proposed according to embodiments of the invention that the piece goods and in particular the plastic parisons are not fed directly for example from a store to the sorting device, but first of all they pass through a dispensing device. A dispensing device, which is described in greater detail below, is generally understood to be a device which in particular transports limited numbers or defined numbers from a bulk supply of plastic parisons and delivers them to the sorting device. In this way the stream of preforms to be fed to the sorting device can be better regulated.

Alignment of the objects or piece goods is in particular understood to mean that they are aligned with regard to their geometric orientation. In particular the piece goods downstream of the sorting device should have a uniform geometric orientation. The sorting device is also suitable and intended for transferring the plastic parisons to a single-track transport. The sorting device aligns the piece goods and in particular plastic parisons in such a way that their longitudinal direction extends vertically and in particular in such a way that they are transported with the mouth upwards.

Thus the (object) dispensing device prevents the objects and in particular piece goods from reaching the sorting in a disordered state and in varying quantities. In this way smoother transport and also smoother sorting of the plastic parisons can be achieved. In this case the dispensing device has a transport unit which transports the plastic parisons along a predetermined transport path. This is a curved transport path and particularly a transport path with a circular curvature.

Thus, in connection with the present patent application dispensing is understood in particular to mean that fluctuations with regard to the quantity of objects reaching the sorting device are kept low. Advantageously the dispensing device ensures that fluctuations of the piece goods reaching the sorting device are less than ±80%, ±60%, ±50% and particularly ±30%.

As mentioned above, the objects are in particular plastic parisons.

The delivery device can be for example a slide or a chute, by means of which the plastic parisons are delivered in particular in a disordered state, for example as a bulk supply.

In further advantageous embodiments the sorting device also has a transport device which transports the plastic parisons along a predetermined transport path. In this case this transport path can extend in a curve or a straight line. However, this transport path extends in a plane. Particularly this transport path extends at least in part and at least in the region of the sorting device in a straight line.

In further advantageous embodiments the dispensing device comprises a plurality of movable receiving means which transport the objects and these receiving means are in each case suitable and intended to receive a predetermined number of objects. Thus, it is possible that in each case a specific number of objects (which may still fluctuate slightly) enters the receiving means and is conveyed from these receiving means. This procedure ensures that ultimately a defined number of plastic parisons or a number of plastic parisons which fluctuates within specific limits is conveyed from the delivery device to the sorting device. In this way a substantially uniform delivery stream of plastic parisons to the sorting device attained can be achieved.

In this case it is possible that each of these receiving means is suitable to receive precisely one plastic parison. However, the individual receiving means or receiver are in each case suitable and intended to receive several plastic parisons. In this case it is conceivable that these receiving means or receiver, receive the plastic parisons in a completely disordered state, that is to say in any orientation. However, it would also be possible that the receiving means or receiver, receive the plastic parisons already in a specific preferred orientation, whereby the subsequent transfer to the sorting device is simplified.

In further advantageous embodiments the dispensing device comprises a body which is rotatable about a predetermined axis of rotation and has on this body receiving means for receiving a predetermined number of objects. In this embodiment it is proposed that the dispensing device ultimately transports the plastic parisons along a circular or arcuate transport path. Thus, the receiving means are suitable and intended to engage in a plurality of plastic parisons and to remove a specific number of these plastic parisons from this plurality.

This axis of rotation is advantageously a substantially horizontally extending axis of rotation. This means that the plastic parisons with the receiving means are carried along an arc which extends in a substantially vertical plane. In addition, however, it would also be possible that the axis of rotation is inclined or arranged vertically. However, the substantially horizontal arrangement offers the advantage of a relatively uniform delivery and a relatively uniform transport of the plastic parisons.

In further advantageous embodiments the receiving means or receiver are in each case configured as cutouts arranged on an external circumference of the body. During a rotation of the said body these cutouts can penetrate into a plurality of plastic parisons and respectively entrain a specific number of plastic parisons. Thus, the cutouts can function in a similar manner to a bucket wheel, which can in each case receive a specific number of piece goods.

In further advantageous embodiments the rotatable body has a plurality of slots parallel to one another at least on its external circumference. In this case it is possible that these slots are only formed on the external circumference of the body, but it is possible and preferred that the rotatable body has a plurality of plates which are formed parallel to one another, so that the slots are also formed between these respective plates.

Thus, it is possible that carrier elements are provided which hold the individual plates of the body against one another. In this case these carriers can also extend for example in the direction of the axis of rotation or parallel to the axis of rotation of the entire body.

In a further advantageous embodiment these slots extend substantially perpendicularly to the axis of rotation of the rotatable body. In this way, as described in greater detail, counterpart means or a counterpart can also engage in the said slots.

In further advantageous embodiments the apparatus has at least one takeoff means or a takeoff which extends at least at times into one of the said slots, into several thereof and particularly into all of the said slots. In this case this takeoff means or takeoff is arranged stationary and the slots move jointly with the body relative to this takeoff means.

In this case the at least one takeoff means or takeoff can be adjusted in such a way that in each case only a specific number of plastic parisons is received and the remaining plastic parisons are taken off again.

In an advantageous embodiment the at least one takeoff means or takeoff is designed in such a way that the same quantity of plastic parisons is always taken off and approximately the same quantity of plastic parisons is transported downstream with respect to the takeoff means or takeoff by each receiving means or receiver or each portion of the dispensing roller. In this case, the quantity of plastic parisons still received by the receiving means downstream of the takeoff means can be changed by a change of position of the takeoff means or takeoff relative to the receiving means or receiver. More precisely, the takeoff means can have feed plates, which are explained in greater detail below, by means of which the quantity of objects or plastic parisons in the receiving means can be set precisely.

In further advantageous embodiments the receiving means have a sawtooth-like profile. Due to this sawtooth-like profile it is particularly advantageously possible to receive delivered plastic parisons and to transport them in a defined manner.

The delivery device advantageously has an inclined surface by means of which the plastic parisons are delivered to the dispensing device. In this case this said sawtooth-like profile is provided in particular in the direction of the axis of rotation of the rotatable body, when viewed in a projection.

In further advantageous embodiments the apparatus has at least two receiving means, at least three receiving means and at least four receiving means and particularly at least five receiving means.

In further advantageous embodiments the rotatable body has at most 30, at most 25 and particularly at most 20 receiving means or receivers. However, the number of receiving means can also be over 30 (for example 60, 80 or even more). It would also be possible that several receiving means are arranged one behind the other along an axis of rotation of the rotatable body.

In further advantageous embodiments, at an inlet of the dispensing device a limiter or means for limiting the number of units is provided, which limits the number of piece goods reaching the dispensing device. Thus, for example a wall can be provided which has a slot which only allows a limited cross-section of plastic parisons to reach the dispensing device. In this way the quantity of plastic parisons reaching the dispensing device can be reduced.

Thus, the above-mentioned saw-tooth roller is used as a dispensing aid. As mentioned above, this roller has multiple slots on the circumference, wherein stationary takeoff plates are arranged in the slots so that the slots of the dispensing roller pass them and one takeoff plate engages each in one slot of the dispensing roller. The contour of the stationary takeoff plate ensures that the preforms are “taken off”. In this case it is possible that the dispensing roller or the rotatable body also has rotating plates which form slots between them in which in each case the takeoff plates are arranged.

In this case these takeoff plates are designed in such a way that during a rotation of the rotatable body they force the objects or plastic parisons located in the respective receiving means outwards (in particular radially) and so a certain proportion of the plastic parisons fall out of the respective receiving means. This dispensing device or dispensing roller removes plastic parisons from a container. In addition, it would also be possible that the plastic parisons are delivered via a delivery means such as for instance a feeder belt. In this situation it would also be possible that the plastic parisons are conveyed directly from the delivery means to the rotatable body, that is to say in particular without the provision of a container.

The above-mentioned takeoff means are particularly adjustable relative to the rotatable body. In this case they can be pivotable and/or deliverable along a line. In this way the quantity of plastic parisons in each case transported in the receiving means can be adjusted.

In further advantageous embodiments a transport device is provided which supplies the delivery device with plastic parisons. In this case for example a main belt and a return belt can be provided, which serve for filling the respective removal container.

In further advantageous embodiments the means for limiting the number of units is designed as a wall which is arranged above the first delivery device and forms a gap with the delivery device. In this case this gap is designed with a transport plane of the delivery device. It is also possible that a first rough alignment of the plastic parisons already takes place through this gap. The delivery device can for example have a conveyor belt and/or a slide which transports the plastic parisons.

Furthermore, it is also conceivable that the quantity of plastic parisons reaching the dispensing device can be controlled by this gap. This gap or the width thereof can be changed, so that the quantity of objects which are received and transported by the dispensing device can be changed.

In further advantageous embodiments the sorting device is designed as a roller sorter or as a disc sorter. In the case of a roller sorter the sorting device has two rotating rollers, between which a gap is formed inside which the plastic parison is guided. Thus, the plastic parisons are transported in the roller sorter along a rectilinear transport path.

In further advantageous embodiments at least one boundary wall is arranged laterally alongside the rotatable body. This is in particular a stationary boundary wall. However, it would also be possible that the boundary wall also rotates and for example likewise delimits the individual receiving means laterally. Plastic parisons are prevented from falling out of the receiving means by these boundary walls.

These boundary walls advantageously form jointly with the receiving means a receiving chamber for receiving the plastic parisons.

The plastic parisons are advantageously conveyed along a semi-circle or generally along a circular path.

Furthermore, embodiments of the present invention are directed to a dispensing device for transporting plastic parisons. This has an inlet by means of which the plastic parisons can be delivered to the dispensing device. Furthermore, the dispensing device has a body which is rotatable about a predetermined axis of rotation, on the external circumference of which a plurality of receiving means is arranged, wherein each of these receiving means is suitable and intended to receive at least one and a plurality of plastic parisons.

The rotatable body is configured in the manner described above.

The axis of rotation is advantageously aligned horizontally. The rotatable body is designed in the manner of a bucket wheel.

In further advantageous embodiments the inlet is designed in such a way that plastic parisons present at the inlet can be received by the receiving means automatically, in particular under the effect of gravity

Furthermore, embodiments of the present invention are directed to a method for sorting objects and in particular plastic parisons. In this case a plurality of plastic parisons are transported from a delivery device to a sorting device and are sorted by this sorting device. In this case, for this sorting, the plastic parisons are at least in some instances uniformly aligned.

According to embodiments of the invention the plastic parisons are transported by means of a dispensing device which is arranged between the delivery device and the sorting device and are transferred by this dispensing device to the sorting device in a dispensed manner.

Therefore, the method also proposes that the plastic parisons are transferred in specific proportions or respective numbers to the sorting device.

The plastic parisons are advantageously transported by the dispensing device along a circular transport path. The plastic parisons are advantageously transported around a predetermined axis of rotation.

In a further preferred method, the plastic parisons are transported by a plurality of receiving means and in particular in groups which are separated from one another. The receiving means are separated spatially from one another by at least one wall.

In a further preferred method the plastic parisons are transported by a transport angle of at least 10°, at least 20°, at least 30°, at least 40°, at least 60°, at least 90° and at least 120°.

The plastic parisons are advantageously transported by a transport angle of less than 300°, less than 270°, less than 250°, particularly less than 230°, and less than 200°.

The plastic parisons advantageously remain held in the receiving means under the effect of gravity at least for a part of their transport path. At a specific rotational position, the plastic parisons also fall out of the receiving means under the effect of gravity.

In further advantageous embodiments the apparatus has a discharge device by which the plastic parisons falling out of the receiving means are further transported. This can be for example a slide device or the like, onto which the plastic parisons fall and which then conveys these plastic parisons to the actual sorting device.

It would also be possible that the apparatus has at least one further and further takeoff means, which are provided in an outlet region of the rotatable body or of the sorting device, these further takeoff means can serve in this case to simplify the further conveying of the plastic parisons to the sorting device.

In further advantageous embodiments the apparatus has a driving device for driving the rotatable body. This driving device is selected from a group of driving devices which includes electrical driving devices, in particular electric motor-powered driving devices, pneumatic driving devices, hydraulic driving devices and the like.

### BRIEF DESCRIPTION

Some of the embodiments will be described in detail, with reference to the following figures, wherein like designations denote like members, wherein:

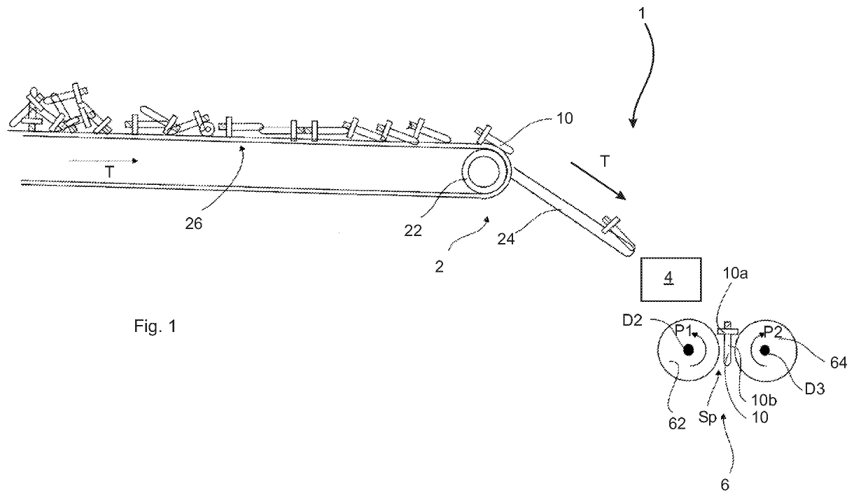

FIG. 1 shows a schematic representation of an apparatus according to embodiments of the invention for sorting plastic parisons;

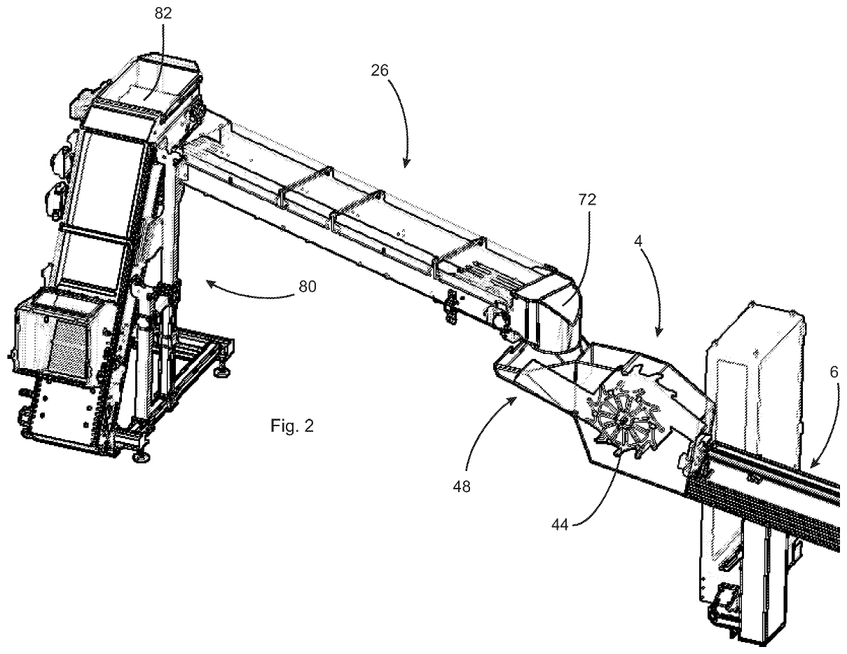

FIG. 2 shows a schematic overall representation of an apparatus according to embodiments of the invention;

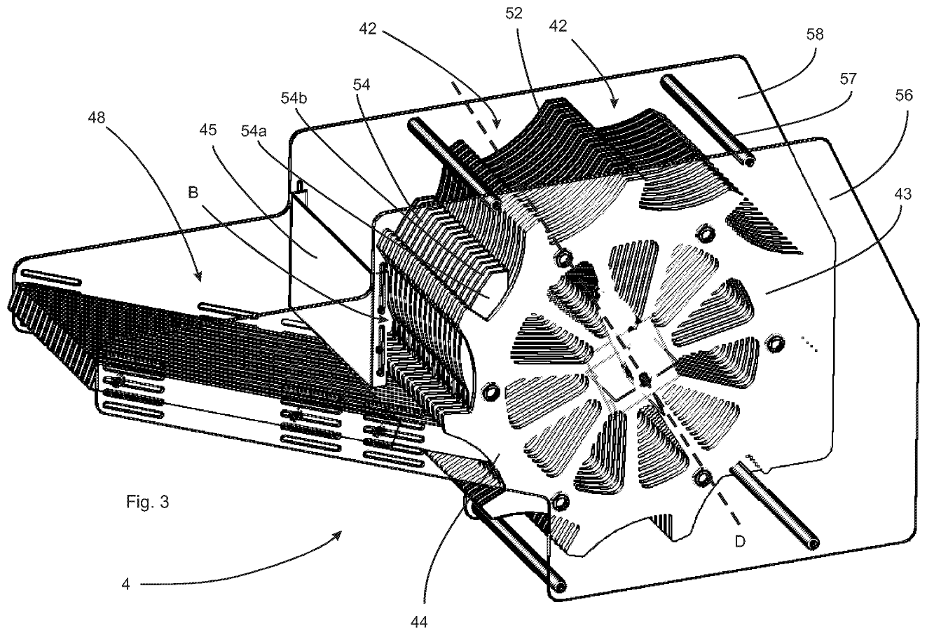

FIG. 3 shows a view of a detail of the dispensing device according to embodiments of the invention; and

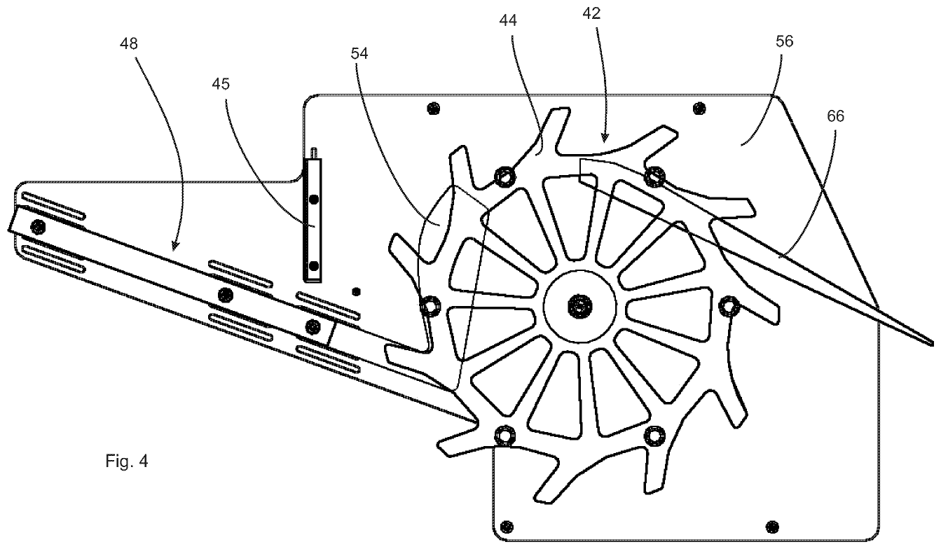

FIG. 4 shows a further representation of a machine according to embodiments of the invention.

### DETAILED DESCRIPTION

FIG. 1 shows an apparatus 1 for sorting plastic parisons 10. This has a first delivery device 2 which delivers plastic parisons 10. In this case this delivery device 2 has a conveyor belt 26 circulating around two deflection rollers (only one illustrated). This conveyor belt 26 is adjoined by a slide 24, along which the plastic parisons 10 slide to a dispensing device 4 which is only shown schematically. The dispensing device 4 dispenses the plastic parisons 10 in the direction of the sorting device 6. In this case the sorting device 6 has two rollers 62 and 64 which are arranged parallel to one another and rotate about axes of rotation D2 and D3 which are parallel to one another. The reference numerals P1 and P2 indicate the respective directions of rotation. In addition, an aligning device (not shown) can be provided which aligns the plastic parisons between the rollers of the sorting device 6. In this case this aligning device can be located between the dispensing device and the sorting device 6. Furthermore, it is also possible for the dispensing of the plastic parisons to take place by an interaction between the dispensing device 4 and a further conveyor device, such as for instance a vertical conveyor.

Between these two rollers 62 and 64 a gap SP is formed which has such a width that a main body 10b of a plastic parison 10 can enter it, but a carrying ring 10a of the plastic parison is held by the rollers 62 and 64 or the external circumferences thereof. In this way a sorting of the individual plastic parisons is achieved in such a way that here they are now transported perpendicularly to the drawing plane and one behind the other.

FIG. 2 shows an overall representation of a system with an apparatus according to embodiments of the invention. This plant for conveying plastic parisons has a first conveyor device 80, such as in particular a so-called vertical conveyor, which conveys plastic parisons (not shown) upwards. Starting from this vertical conveyor, the plastic parisons pass onto the conveyor belt 26 and are conveyed via an outlet 72 thereof and a feed rail 48 to the dispensing device 4. The reference numeral 6 in turn designates the sorting device such as a roller sorter. The quantity of plastic parisons reaching the sorting device can be controlled by means of an interaction between the vertical conveyor 80 and the dispensing device. The reference numeral 82 relates to a receiving device into which the plastic parisons are conveyed by the conveying device.

FIG. 3 shows a representation of the dispensing device 4. This dispensing device has a feed rail 48 which extends obliquely here and along which plastic parisons (not shown) are delivered to a delivery region B. The reference numeral 45 designates a limiting means or limiter which with the feed rail 48 forms a gap so that the number of plastic parisons reaching the delivery region B is limited.

The reference numeral 44 designates a body which is rotatable about an axis of rotation D and has a plurality of receiving means or receiver 42 on its outer circumference. These receiving means can enter the plastic parisons and in this way in each case only limited numbers of plastic parisons are transported by the individual receiving means or receiver 42.

The rotatable body here has a plurality of plates 43 which are arranged parallel to one another and in each case form a gap 52 between them. The reference numeral 54 designates a takeoff means or takeoff which enters this gap. The takeoff means or takeoff also has a plurality of plates or strips 54a, 54b which in each case enter the gap 52.

The reference numerals 56 and 58 designate lateral boundary walls which are arranged stationary. Due to these boundary walls the receiving means form common receiving volumes for receiving the plastic parisons. The reference numerals 57 designate bars which hold the two walls 56 and 58 against one another. The plastic parisons (not shown) are therefore received by the individual receiving means on the left-hand region in the delivery region B. The takeoff means ensure that defined numbers of plastic parisons are located in the receiving means 42 and are transported thereby. In this case it is conceivable that the takeoff means can be adjusted as a whole, for example they can be shifted in a straight line or also swivelled. In this way the number of plastic parisons which as a result are still located in the receiving means can be controlled.

FIG. 4 shows a further schematic representation of an apparatus according to embodiments of the invention. In this case a further takeoff means 66 is also shown which serves to convey the plastic parisons more easily out of the respective receiving means. In this case this further takeoff means can also have a slide element which conveys the plastic parisons further to the sorting device (not shown).

Different parameters of the apparatus shown in FIG. 4 are advantageously adjustable. Thus, the position of the takeoff means 54 is advantageously adjustable relative to the rotatable body 44. In this way it is possible to set how many plastic parisons are conveyed in each case by the individual receiving means. A rate of rotation of the rotatable body 44 can also be set.

Although the invention has been illustrated and described in greater detail with reference to the preferred exemplary embodiment, the invention is not limited to the examples disclosed, and further variations can be inferred by a person skilled in the art, without departing from the scope of protection of the invention.

For the sake of clarity, it is to be understood that the use of “a” or “an” throughout this application does not exclude a plurality, and “comprising” does not exclude other steps or elements.

### LIST OF REFERENCES

1 apparatus
2 delivery device
4 dispensing device
6 sorting device
10 plastic parisons
10a carrying ring
10b main body
24 slide
26 conveyor belt
42 receiving means or receiver
43 plates
44 rotatable body
45 limiting means or limiter
48 feed rail
52 gap
54 takeoff means or takeoff
54a,b plates of the takeoff means
56, 58 lateral boundary walls
57 bars
62, 64 rollers
66 further takeoff means or takeoffs
72 outlet
80 conveying device, vertical conveyor
82 receiving device
D2, D3 axes of rotation
SP gap
B delivery region
D axis of rotation

1. An apparatus for sorting piece goods including plastic parisons with a delivery device which delivers the piece goods and with a sorting device which is arranged in a transport direction of the piece goods after the delivery device and is suitable for aligning the piece goods at least partially, and with a dispensing device which is arranged in the transport direction of the piece goods between the delivery device and the sorting device and which conveys the piece goods from the delivery device to the sorting device and is suitable and intended for dispensing the piece goods reaching the sorting device from the delivery device, wherein the dispensing device comprises a body which is rotatable about a predetermined axis of rotation and on this body a receiver is arranged for receiving a predetermined number of piece goods.

2. The apparatus according to claim 1, wherein the dispensing device comprises a plurality of movable receivers which transport the piece goods and these receivers are in each case suitable and intended to receive a predetermined number of piece goods.

3. The apparatus according to claim 1, wherein the axis of rotation is a horizontally extending axis of rotation.

4. The apparatus according to claim 1, wherein the receiver is in each case configured as a cutout arranged on an external circumference of the body.

5. The apparatus according to claim 1, wherein the rotatable body has at least on its outer circumference a plurality of slots which are parallel to one another.

6. The apparatus according to claim 5, wherein these slots extend substantially perpendicularly to the axis of rotation of the rotatable body.

7. The apparatus according to claim 1, wherein the apparatus has at least one takeoff.

8. The apparatus according to claim 1, wherein the takeoff extends at least at times into the slots.

9. The apparatus according to claim 2, wherein the receiver has a sawtooth-like profile.

10. The apparatus according to claim 1, wherein a limiter for limiting the number of units which limits a number of piece goods reaching the dispensing device is provided in an inlet of the dispensing device.

11. The apparatus according to claim 10, wherein this limiter for limiting the number of units is designed as a wall which is arranged above the first delivery device and forms a gap with the delivery device.

12. The apparatus according to claim 1, wherein the sorting device is designed as a roller sorter or as a disc sorter.

13. The apparatus according to at least claim 1, wherein at least one boundary wall is arranged laterally adjacent to the body.

14. A dispensing device for transporting plastic parisons, with an inlet by which the plastic parisons can be delivered to the dispensing device, with a body which is rotatable about a predetermined axis of rotation and on the external circumference of which a plurality of the receivers is arranged, wherein each of these receiving means is suitable and intended to receive at least one and a limited plurality of plastic parisons.

15. A method for sorting objects including plastic parisons, wherein a plurality of plastic parisons are transported from a delivery device to a sorting device and are sorted by this sorting device, wherein for this sorting the plastic parisons are uniformly aligned at least in some instances, wherein by a dispensing device the plastic parisons are transported by a dispensing device which is arranged between the delivery device and the sorting device, and are transferred by this dispensing device to the sorting device in a dispensed manner.
